(19) United States
(12) Patent Application Publication
(10) Pub. No.: US 2019/0114587 A1
(43) Pub. Date: Apr. 18, 2019

(54) SYSTEMS AND METHODS FOR A ROUTING SYSTEM

(71) Applicant: Walmart Apollo, LLC, Bentonville, AR (US)

(72) Inventors: Shaik Asifullah, Andra Pradesh (IN); Ayushi Jain, Uttar Pradesh (IN); Kashish Mehrotra, Uttar Pradesh (IN); Prabhat Kumar, Rajasthan (IN); Aditya Dalwani, Bangalore (IN); Balaji Muniswami, TamilNadu (IN)

(21) Appl. No.: 15/866,449

(22) Filed: Jan. 9, 2018

(30) Foreign Application Priority Data
Oct. 12, 2017 (IN) 201711036235

(51) Int. Cl. G06Q 10/08; G06Q 10/04

(52) U.S. Cl. CPC G06Q 10/08355; G06Q 10/0833; G06Q 10/047

(57) ABSTRACT

A routing system is discussed that receives data for multiple orders, including, for each order, a first destination with a corresponding first time window and a second destination and a corresponding second time window. The routing system analyzes data for multiple orders, and generates an optimized route for delivery taking into consideration logistic constraints and cost efficiency.

### RELATED APPLICATIONS

This application claims priority to Indian Patent Application No. 201711036235 entitled “SYSTEMS AND METHODS FOR A ROUTING SYSTEM,” filed on Oct. 12, 2017, the contents of which is hereby incorporated by reference in its entirety.

### BACKGROUND

Routing systems must take into account multiple destinations. Additional considerations include corresponding time windows for each destination. Routing systems analyze data for multiple destinations and generate a route.

### SUMMARY

In one embodiment, a routing system is provided that includes a database, a user interface, and a server. The database holds data related to multiple orders. The user interface is configured to accept an order for delivery of items where the order includes a first destination and a corresponding first time window, and a second destination and a corresponding second time window. The server is equipped with one or more processors and is in communication with the database. The server is configured to execute a routing optimizer engine that when executed receives data for the multiple orders, where each order includes a first destination with a corresponding first time window. The routing optimizer engine also generates and stores an initial route in the database for delivering each order of the multiple orders at the corresponding first destinations within the first time window by analyzing the data for the multiple orders. The routing optimizer engine removes two or more outlier orders from the generated initial route based on pre-defined logistical constraints to form a subset of orders of the multiple orders. The routing optimizer engine generates and stores a first partial route for delivering each order of the subset of orders at the corresponding first destinations within the first time window, and iteratively inserts one of the two or more outlier orders into the subset of orders. For each iteration, the routing optimizer engine generates and stores a second set of partial routes for delivering each order of the subset of orders at the corresponding first destination within the first window and the one inserted outlier order at the corresponding second destination within the second time window. During each iteration, the routing optimizer engine compares the first partial route, and the second set of partial routes, and determines that the first partial route or one of the second set of partial routes is an optimized route between a source and destination based on the pre-defined logistical constraints, and stores the optimized route in the database.

In another embodiment, a computer-implemented method for a routing system is provided. The method includes receiving data for multiple orders, where each order includes a first destination with a corresponding first time window and a second destination and a corresponding second time window. The method also includes generating and storing an initial route in the database for delivering each order of the multiple orders at the corresponding first destinations within the first time window by analyzing the data for the multiple orders. The method further includes removing two or more outlier orders from the generated initial route based on pre-defined logistical constraints to form a subset of orders of the plurality of orders, and generating and storing a first partial route for delivering each order of the subset of orders at the corresponding first destinations within the first time window. The method includes iteratively inserting one of the two or more outlier orders into the subset of orders. Each iteration includes generating and storing a second set of partial routes for delivering each order of the subset of orders at the corresponding first destination within the first window and the one inserted outlier order at the corresponding second destination within the second time window. Each iteration further includes comparing the first partial route and the second set of partial routes, determining that the first partial route or one of the second set of partial routes is an optimized route between a source and destination based on the pre-defined logistical constraints, and storing the optimized route in the database.

In another embodiment, a non-transitory machine readable medium is provided that stores instructions that when executed causes a processor to implement a method for a routing system. The method includes receiving data for multiple orders, where each order includes a first destination with a corresponding first time window and a second destination and a corresponding second time window. The method also includes generating and storing an initial route in the database for delivering each order of the multiple orders at the corresponding first destinations within the first time window by analyzing the data for the multiple orders. The method further includes removing two or more outlier orders from the generated initial route based on pre-defined logistical constraints to form a subset of orders of the plurality of orders, and generating and storing a first partial route for delivering each order of the subset of orders at the corresponding first destinations within the first time window. The method includes iteratively inserting one of the two or more outlier orders into the subset of orders. Each iteration includes generating and storing a second set of partial routes for delivering each order of the subset of orders at the corresponding first destination within the first window and the one inserted outlier order at the corresponding second destination within the second time window. Each iteration further includes comparing the first partial route and the second set of partial routes, determining that the first partial route or one of the second set of partial routes is an optimized route between a source and destination based on the pre-defined logistical constraints, and storing the optimized route in the database.

### BRIEF DESCRIPTION OF DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram showing a routing system implemented in modules, according to an exemplary embodiment;

FIG. 2A is a flowchart showing an exemplary method for a routing system, according to an exemplary embodiment.

FIG. 2B is a flowchart illustrating an exemplary method for generating an optimized route for fulfilling a batch of orders.

FIG. 3 is a schematic illustrating an exemplary order management system including a routing system, according to an exemplary embodiment;

FIG. 4 is a schematic illustrating an exemplary order management system, according to an exemplary embodiment;

FIG. 5 is a schematic illustrating an exemplary routing system, according to an exemplary embodiment;

FIG. 6 is a schematic illustrating an exemplary user interface for placing an order, according to an exemplary embodiment;

FIG. 7 illustrates a network diagram depicting a system for implementing a distributed embodiment of the routing system, according to an exemplary embodiment; and

FIG. 8 is a block diagram of an exemplary computing device that can be used to implement exemplary embodiments of the routing system described herein.

### DESCRIPTION OF EXEMPLARY EMBODIMENTS

Exemplary embodiments of the present disclosure provide systems, methods and non-transitory computer readable medium for a routing system. Exemplary embodiments include receiving multiple delivery destinations or addresses and a corresponding time window for each destination when a customer is available to accept delivery. The routing system analyzes data for multiple orders, and generates an optimized route for delivery taking into consideration logistic constraints and cost efficiency with respect to a company (eCommerce or shipping company).

Currently, customers of eCommerce portals are not usually provided with the option of entering multiple delivery locations for a single order based on actual time of delivery. There is potential to improve customer experience and also to minimize the costs borne by the eCommerce company in serving the customer. For example, the customer may be at home or at the office at different times during the day. The routing system described herein enables a company to reach the customer in a single attempt while minimizing the cost to the company.

Exemplary embodiments of the routing system described herein allow customers to enter multiple delivery locations at the time of order placement, and to provide corresponding time slots of availability at each delivery location. During processing of the orders in the fulfillment stage, the routing system, which includes a routing optimizer engine, selects a location for delivery in such a manner that assures not only the satisfaction of logistic constraints, but also picks the delivery location in a manner that optimizes the cost borne by the company in this fulfillment activity. The routing system not only improves customer experience, but also allows the eCommerce company make an informed, cost-efficient decision about where and when to fulfill the order in a manner that prevents overhead costs of having to attempt re-delivery in case of a failed delivery attempt.

The routing optimizer engine forms an important piece in the order fulfillment deployment flow. The routing optimizer engine takes as input a batch of customer orders with multiple locations and corresponding time windows for each of the locations. Using either an approximate solution of the Vehicle Routing Problem based on a heuristic, or a genetic algorithm, or a combination of both of these, the optimizer creates a set of optimal routes. A genetic algorithm may be configured to minimize the cost function given the source and destination along with intermediate points. Optimal routes are those which not only fulfill all the constraints posed, including customer demands as well as a company's logistic constraints, but also optimize the overall delivery cost that the company bears.

In exemplary embodiments, the routing system described herein receives data for multiple orders. Data for each order includes at least a first destination and a corresponding first time window, and a second destination and a corresponding second time window. The information for the first destination, first time window, second destination and the second time window is received from a user or a customer via a user interface generated on a client device. A server including a processor is configured to execute a routing optimizer engine. The routing optimizer engine analyzes order data for multiple orders, and generates and stores an initial route to deliver each order of the multiple orders to the first destination within the first time window. Then the routing optimizer engine removes two or more outlier orders based on pre-defined logistics constraints to form a subset of orders and generates and stores a first partial route for delivering each order in the subset of orders. The routing optimizer iteratively inserts one of the two or more outliers into the subset of orders, and generates multiple second partial routes for delivering orders to the subset of orders and the inserted outlier. The multiple second partial routes are stored in a database. The routing optimizer engine compares the first partial route and the multiple second partial routes, and determines which one of the partial routes is an optimized route based on pre-defined logistics constraints. The routing optimizer iteratively inserts any unfulfilled orders into the subset of orders, and runs until all orders are fulfilled and the most optimized route is determined for fulfilling all of the orders.

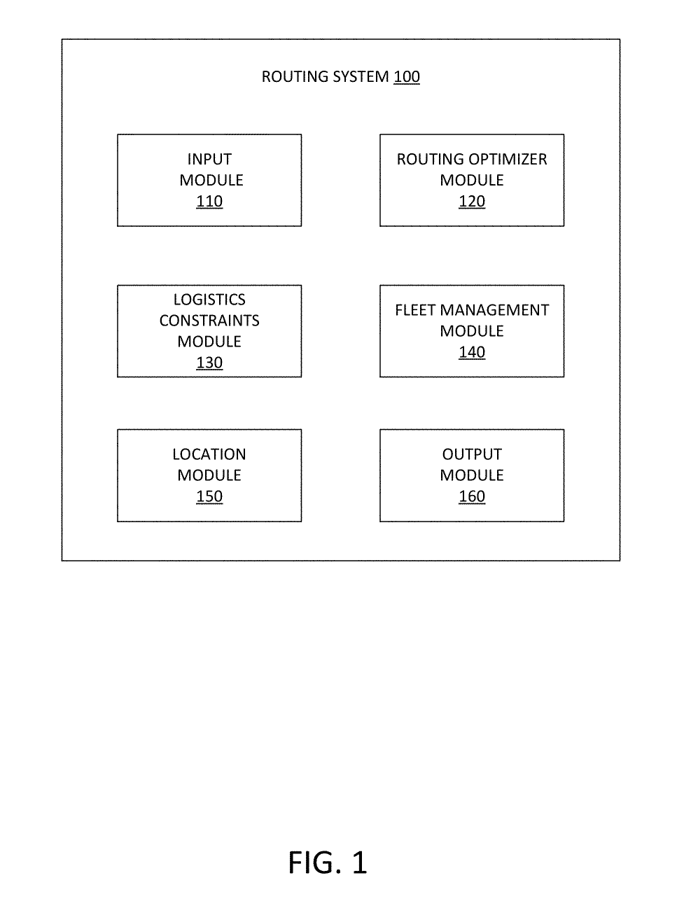

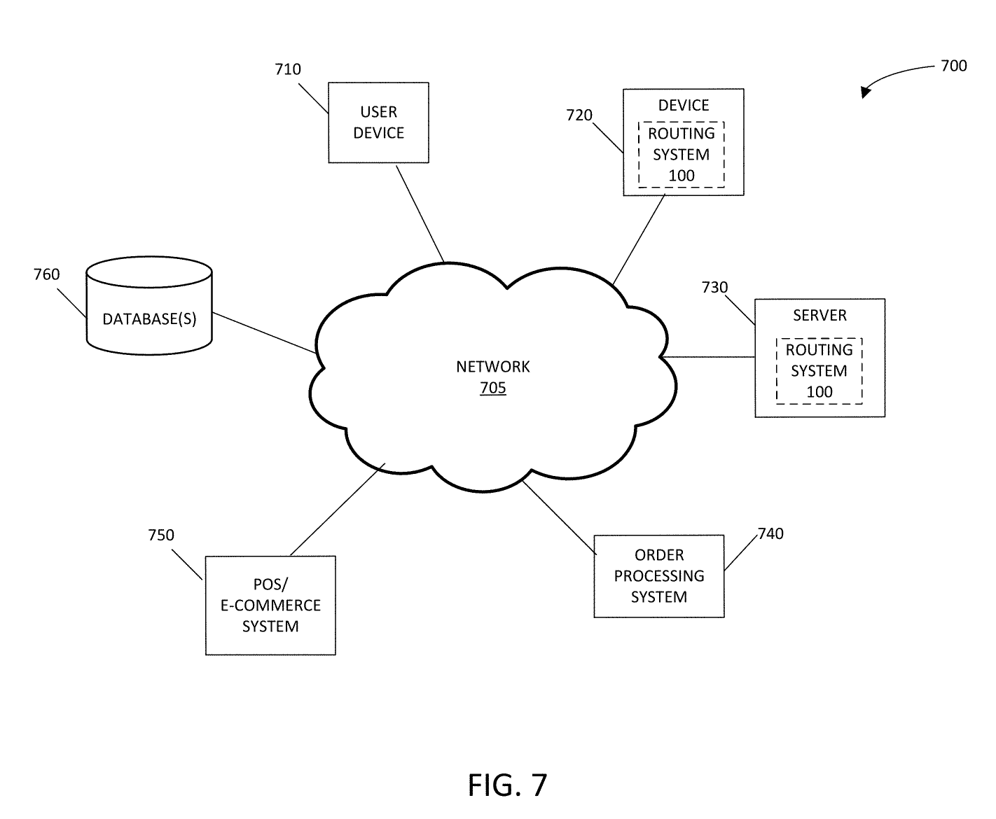

FIG. 1 is a block diagram showing a routing system 100 in terms of modules according to an exemplary embodiment. One or more of the modules may be implemented using device 720, and/or server 730 as shown in FIG. 7. The modules include an input module 110, a routing optimizer module 120, a logistics constraints module 130, a fleet management module 140, a location module 150, and an output module 160. The modules may include various circuits, circuitry and one or more software components, programs, applications, or other units of code base or instructions configured to be executed by one or more processors. In some embodiments, one or more of modules 110, 120, 130, 140,150, 160 may be included in server 430, while other of the modules 110, 120, 130, 140, 150, 160 are provided in device 420. Although modules 110, 120, 130, 140, 150, and 160 are shown as distinct modules in FIG. 1, it should be understood that modules 110, 120, 130, 140, 150, and 160 may be implemented as fewer or more modules than illustrated. It should be understood that any of modules 110, 120, 130, 140, 150 and 160 may communicate with one or more components included in system 700 (FIG. 7), such as user device 710, device 720, server 730, order processing system 740, POS/e-commerce system 750, or database(s) 760.

The input module 110 may be a software or hardware-implemented module configured to receive and manage data related to orders placed by customers. The input module 110 is configured to receive at least a first destination and a corresponding first time window, and a second destination and a corresponding second time window.

The routing optimizer module 120 may be a software or hardware-implemented module configured to analyze order data and generate various routes to fulfill order delivery in an optimized manner that is most cost and time efficient for the shipping or delivery company.

The logistics constraints module 130 may be a software or hardware-implemented module configured to receive and manage logistics constraints on delivering orders. Logistics constraints may be provided by the shipping or delivery company and may include, but are not limited to, number of delivery vehicles, capacity of a delivery vehicle, hours of operation, number of drivers, geographic area assigned to a driver, and others. In some embodiments, logistics constraints may also include weather information (real-time and/or forecasted), traffic information (real-time and/or forecasted), user or customer defined preferences, delivery address type (residential type or office type) and the like.

The fleet management module 140 may be a software or hardware-implemented module configured to manage and update data for a fleet of delivery vehicles. The fleet management module 140 may manage real-time information on vehicles in a fleet that are dispatched for delivery, vehicles that are available for dispatch, vehicles that are out-of-service, and the like.

The location module 150 may be a software or hardware-implemented module configured to manage location information for each delivery vehicle in a fleet.

The output module 160 may be a software or hardware-implemented module configured to manage and store the optimized route for delivering orders generated by the routing optimizer module 120.

In an example embodiment, the routing system employs a heuristic algorithm called ‘ruin and recreate’ to generate an optimized route for delivering orders by analyzing more than one destination address. The ruin and recreate algorithm is an iterative algorithm that in each iteration tries to ruin a generated route to remove sub-optimal components in the route and then aims to recreate the routes more optimally by analyzing the other destination addresses and corresponding time windows.

In another embodiment, the routing system employs an algorithm from the class of Genetic Algorithms A genetic algorithm may be used in combination with the algorithms or methods described herein.

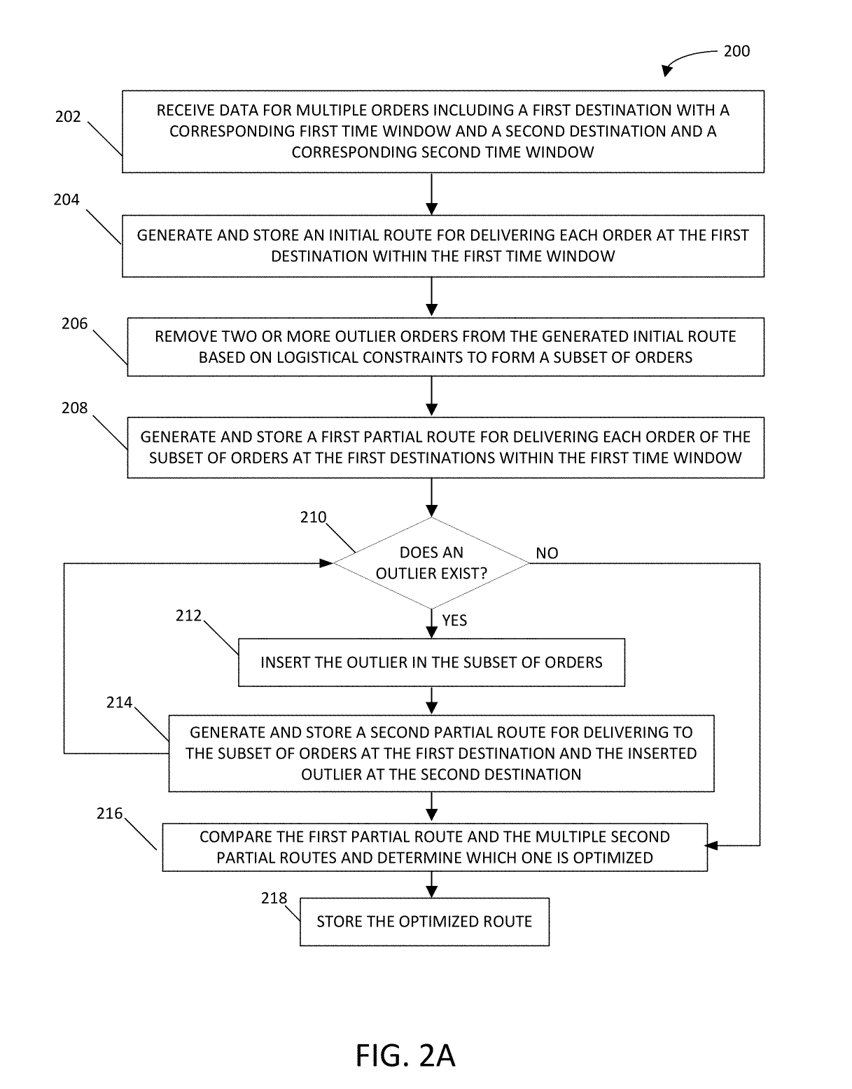

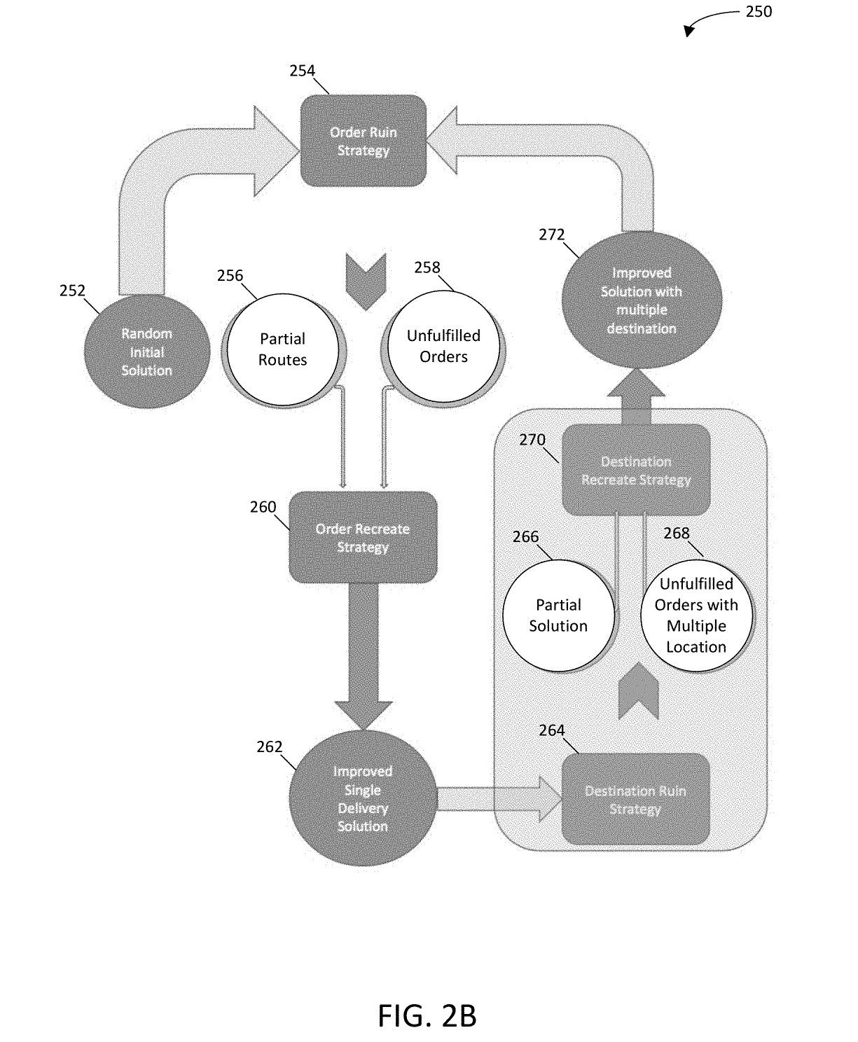

FIG. 2A is a flowchart showing an exemplary method for a routing system, according to an exemplary embodiment. The method 200 may be performed using the modules in the routing system 100 shown in FIG. 1 and the components described with reference to FIG. 7.

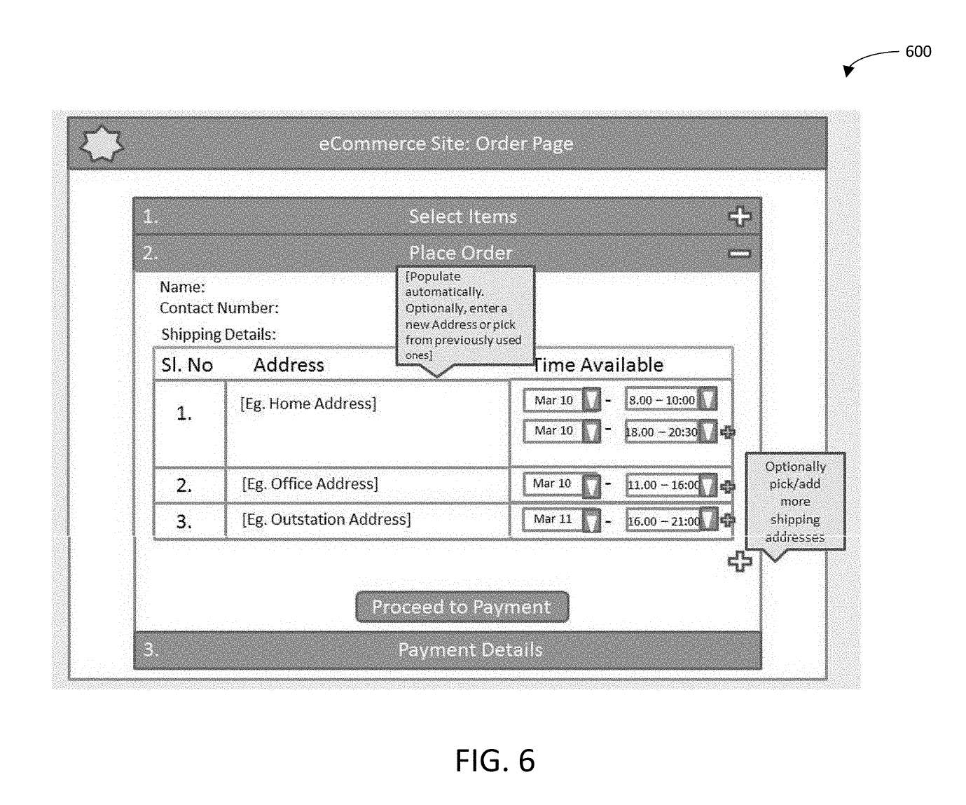

At step 202, the input module 110 receives data for multiple orders. Each order includes at least a first destination with a corresponding first time window and a second destination with a corresponding second time window. In some embodiments, an order may include more than two destinations and corresponding time windows. The first and second destination include respective addresses for delivery of an order placed by a customer. The order also includes corresponding time windows for delivering an order at the respective destination. For example, when placing the order the customer inputs a first destination and a corresponding first time window for delivering the order at the first destination within the first time window, and also a second destination and a corresponding second time window for delivering the order at the second destination within the second time window. With these inputs, the customer can indicate multiple delivery addresses and when the customer or another person will be available at the respective address to accept delivery. An exemplary user interface for inputting multiple delivery addresses and time windows is shown in FIG. 6. The order data and information may be stored in a database (e.g., database(s) 760), and the input module 110 retrieves the order data and information from the database.

At step 204, the routing optimizer module 120 generates and stores an initial route in the database for delivering each of the multiple orders at the corresponding first destinations within the first time window by analyzing the data for the orders.

In some embodiments, the routing optimizer module 120 receives pre-defined logistic constraints including a number of vehicles, hours of operations, and vehicle capacity. The logistic constraints may be managed and stored by the logistics constraints module 130. The route optimizer module 120 may generate and store the initial route for delivering each of the multiple orders at the corresponding first destinations within the first time windows by analyzing the data for the orders and the pre-defined logistics constraints.

At step 206, the routing optimizer module 120 removes two or more outlier orders from the generated initial route based on pre-defined logistical constraints to form a subset of orders of the multiple orders. In some embodiments, the outlier order may be an order that has a delivery address outside a specified radius from the generated initial route. In some embodiments, the outlier order may be determined to be an outlier because the cost of delivering to the order exceeds a threshold. In an example embodiment, the outlier order may be determined to be an outlier based on other logistics constraints, such as weather, traffic, user preferences, and the like.

At step 208, the routing optimizer module 120 generates and stores a first partial route for delivering each order of the subset of orders at the corresponding first destinations within the first time window.

At step 210, the routing optimizer module 120 determines if an outlier was removed and has not been inserted in the subset of orders. At step 212, if a removed and non-inserted outlier exists, the routing optimizer module 120 inserts the outlier order in the subset of orders.

At step 214, the routing optimizer module 120 generates a second partial route for delivering each order of the subset of orders at the corresponding first destination within the first window and the one inserted outlier order at the corresponding second destination within the second time window. Steps 212 and 214 are repeated for each outlier removed at step 206, causing multiple second partial routes to be generated.

At step 216, the routing optimizer module 120, compares the first partial route, and the multiple second partial routes generated at step 214. At step 216, the routing optimizer module 120 determines that the first partial route or one of the second partial routes is an optimized route between a source and destination based on the pre-defined logistics constraints.

In some embodiments, the routing optimizer module 120 compares a cost of the first partial route and the cost of each of the second partial routes, and determines which one of the first partial route or the second partial routes is an optimized route between the source and destination based on the cost. In an example embodiment, the cost for a route includes a fuel component where the cost is the cost of fuel for traversing the route. In another example embodiment, the cost for a route includes a wage component where the cost is the amount of wages owed to a driver or operator of the vehicle to traverse the route.

At step 218, the routing optimizer module 120 stores the optimized route in the database. In some embodiments, the output module 160 may be configured to transmit instructions to a vehicle to follow an optimized route for delivery that is generated by the routing optimizer module 120.

FIG. 2B is a flowchart illustrating an exemplary method 250 for generating an optimized route for fulfilling a batch of orders. The method 250 may be performed using the modules in the routing system 100 shown in FIG. 1 and the components described with reference to FIG. 7. The method 250 is a ‘ruin and recreate’ algorithm.

At block 252, the routing system 100 generates an initial random route to fulfill all the orders in the batch. At block 254, the routing system 100 ruins the random route by disassembling or disconnecting the connections between two delivery locations.

At block 256, the routing system 100 generates partial routes for fulfilling a subset of the orders in the batch. At block 258, the routing system 100 determines a set of outlier orders and removes them from fulfillment. At block 260, the routing system 100 applies an order recreate strategy using the partial routes from block 256 and the unfulfilled orders from block 258. At block 260, the routing system 100 inserts one or more of the unfulfilled orders into one or more partial routes to generate a new route to fulfill a subset of the orders. Partial optimized routes generated from a few orders and remaining orders are merged in such a way that the cost is decreased (compared to the previous run). A single delivery point is selected from each of the orders belonging to the unfulfilled orders and the algorithm tries to locate its best position in the already optimized partially route.

At block 262, a single delivery location destination (among the list of destinations) is selected for delivery for each order. This results in an improved delivery route based on the cost for each route that encompasses all orders belonging to the interval.

At block 264 a destination ruin strategy is applied in which the final destination to be reached from the list of nodes is selected from the previous step (step 262), is changed and the system attempts to optimize the path by selecting a destination for which the path taken from source to destination (passing through all intermediate nodes) is reduced.

At block 266, the system then determines an optimized path for a selected order using a greedy approach or a Brute force technique on a limited number of orders.

At block 268, the system examines the orders that are unfilled and among the multiple destinations for each order, a destination is picked for each order and the path is again optimized. This time the change is the final destination (of the complete route taken) which is different from the previous iteration.

At block 270, unfilled orders are merged into an already optimized route.

At block 272 the final determination is reached reflecting that in every iteration the score from the final result is improved such that after a certain number of iterations the result is near optimal.

As a non-limiting example, the Example 1 inputs are provided to the routing system 100 and the routing system 100 generates Example 1 outputs in response.

A parameter called ‘pick due timestamp’ is generated based on the priority of the order being fulfilled which can further depend on various parameters such as elite customer status, delivery date or other factors. The routing system 100 partitions the orders based on the batch window for which the algorithm is run. The batch window (or interval) may be between 15 minutes to 60 minutes based on the frequency of the orders received by the order management system.

Example 1 Inputs

Customer[id=268919, locations={(17,7), (5,28)}]

Customer[id=570138, locations={(13,87)}]

In the example 1 inputs, each line represents one order by one customer. The id is an identifier for the order. The locations is a list of delivery locations for the order represented as (latitude, longitude). The latitude and longitude for a delivery location may be determined based on a specified geographic area or map, and corresponds to a latitude and longitude for that specified limited geographic area or map. In example 1, order id: 268919 has two delivery locations associated with it, while order id: 570138 has one delivery location associated with it. The routing system 100 takes example 1 inputs, and generates example 1 outputs shown below.

Example 1 Outputs

[Cost: 175.948730 Route1: {(id=570138, x=13, y=87) (id=268919, x=5, y=28)}]

[Cost: 186.450616 Route2: {(id=570138, x=13, y=87) (id=268919, x=17, y=7)}

The routing system 100 generates two routes and the cost for each route. The first route is generated to fulfill order id: 570138 at the one provided delivery location (13, 87) and to fulfill order id: 268919 at one of the two provided delivery locations (5, 28). The second route is generated to fulfill order id: 570138 at the one provided delivery location (13, 87) and to fulfill order id: 268919 at the other of the two provided delivery locations (17, 7). The routing system 100 calculated the cost for fulfilling orders according to the first route and the second route. As shown, the cost for fulfilling the two orders according to the first route is less than the cost for fulfilling the two orders according to the second route.

It should be appreciated that in practice the actual inputs and outputs for the routing system would be larger in number than those discussed herein. For example, there may be 10 inputs representing orders, and the system may generate 1000 generated routes as outputs. The routing system 100 selects the route with the least cost as the optimized route for fulfilling the orders. As such, from the above example outputs, the routing system 100 selects the route with cost 175.948730.

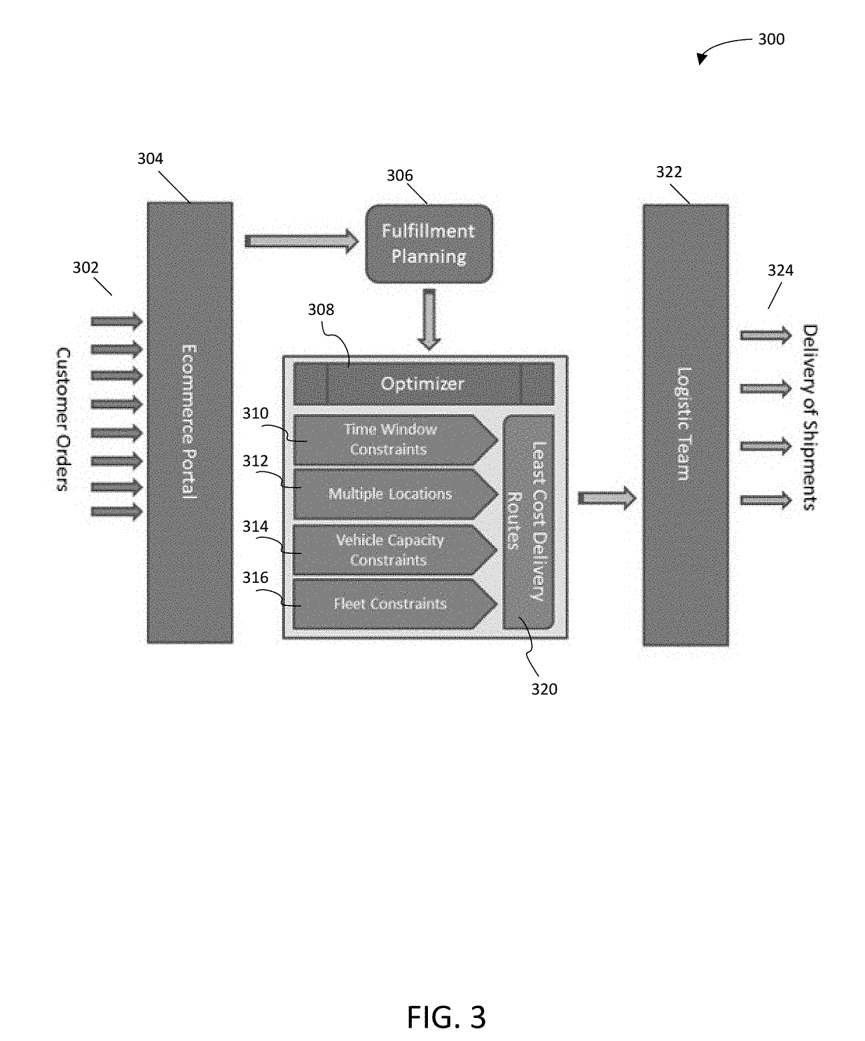

FIG. 3 is a schematic illustrating an exemplary order management system 300 including the routing system, according to an exemplary embodiment. The order management system 300 receives orders 302 from customers via an eCommerce portal 304. The eCommerce portal may be a website provided by a company and hosted on a server to enable users to browse items, complete transactions, and place orders for delivery. The data for the orders 302 is transmitted to a fulfillment planning system 306 that is configured to fulfill the orders 302. The fulfillment planning system 306 transmits the order data to a routing optimizer engine 308. The routing optimizer engine may include one or more software applications or processes executing on a server. As described herein, the routing optimizer engine 308 analyzes the order data to generate an optimized delivery route that is a least cost delivery route for the order fulfillment company or shipping company. As shown, the routing optimizer engine 308 may take into consideration time window constraints 310, multiple delivery locations 312, delivery vehicle capacity constraints 314, and fleet constraints 316. It will be appreciated that the routing optimizer engine may also consider additional factors in addition to, or in place of, those depicted in FIG. 3 when determining a least cost delivery route without departing from the scope of the present invention. The routing optimizer engine 308 outputs a least cost delivery route 320. Data for the generated route 320 is transmitted to a logistics system 322, which uses the route 320 to complete delivery of the orders.

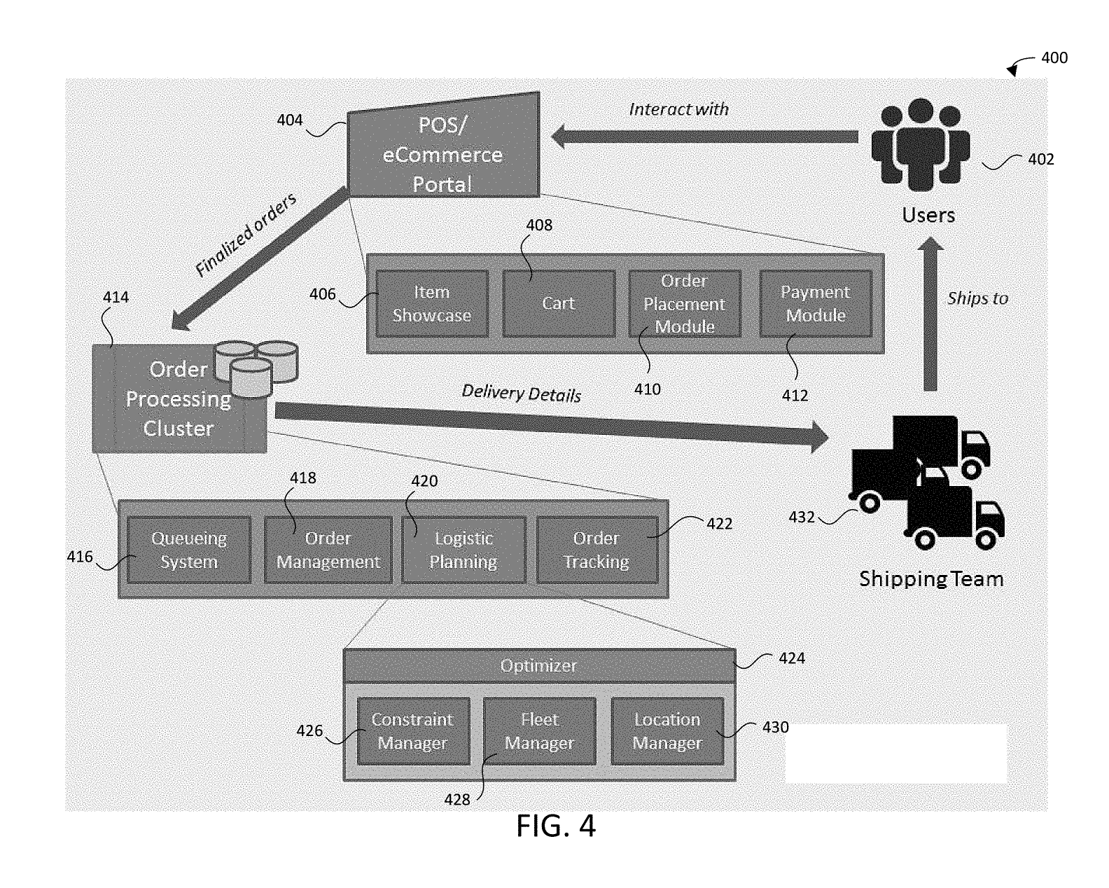

FIG. 4 is a schematic illustrating an exemplary order management system 400, according to an exemplary embodiment. As shown in FIG. 4, customers or users 402 interact with a POS/eCommerce portal 404 to complete transactions and place orders. The POS/eCommerce portal 404 includes multiple components to facilitate transactions and order placement. These components may be hardware or software implemented components and can include item showcase 406, shopping cart 408, order placement module 410, and payment module 412. The POS/eCommerce portal 404 transmits data for placed orders to an order processing cluster 414.

The order processing cluster 414 includes multiple components to facilitate fulfillment of orders. These components may be hardware or software implemented components and can include a queueing system 416, an order management system 418, a logistic planning system 420, and an order tracking system 422. The logistic planning system 420 includes a routing optimizer system 424 that performs the functionalities of the routing system described herein. The routing optimizer system 424 includes hardware or software implemented components including a constraint manager 426, a fleet manager 428, and a location manager 430. The constraint manager 426 is configured to integrate and ensure that various constraints associated with the multiple orders are satisfied when generating or determining the optimized route for fulfilling the orders. The constraints may include separation of sections of the orders into different packages due to the nature of the two products (such as detergent and meat, for example). The constraints may also include the vehicle capacity in terms of dimension and weight, including intermediate stages of packaging (smaller packages into bigger containers).

The fleet manager 428 is configured to manage a set of available resources for delivering or fulfilling the orders. The fleet of vehicles available for a particular chunk of orders can be viewed as a set of available resources. This fleet manager 428 handles the consumption of these resources in order to satisfy the requirements of the least cost realized by a shipping or fulfillment company.

The location manger 430 is configured to select a delivery location for each individual order in the batch that has multiple delivery locations available or indicated for the order. Varying the location across all orders impacts the final outcome (i.e. the final optimized route), and the location manager 430 is configured to select a delivery location iteratively until the best result is obtained.

The order processing cluster 414 transmits data for delivery, including an optimized route for delivery, to a shipping system 432. In some embodiments, the shipping system 432 transmits delivery route instructions to a device used by vehicle operators or to a device installed in a delivery vehicle.

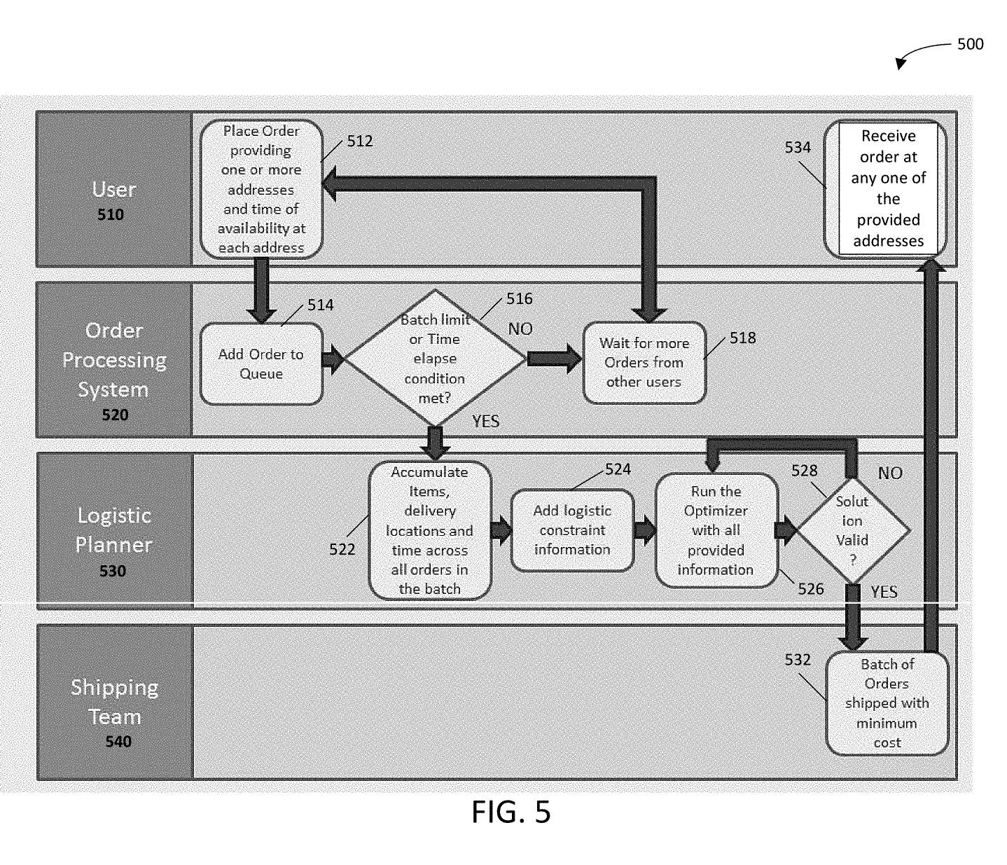

FIG. 5 is a schematic illustrating an exemplary process 500 for the routing system, according to an exemplary embodiment. The process 500 begins at block 512 when a customer or user 510 places an order and provides two or more addresses and corresponding time availability at each address. An order processing system 520 adds the order placed by the user to a queue at block 514. At block 516, the order processing system determines if a batch limit or time elapse condition has been met. The batch limit condition is a minimum number of orders in the queue. That is, the order processing system 520 does not begin processing orders until a minimum number of orders have been queued. In an example embodiment, a minimum number of orders may be approximately 100 orders. In another embodiment, the minimum number of orders may be between 100 to 1000 orders. The time elapse condition is a pre-defined amount of time elapsed since the order was placed. That is, the order processing system 520 does not begin processing orders in the queue until a pre-defined amount of time has elapsed since the order was placed. In an example embodiment, the pre-defined amount of time is approximately 15 minutes. In another example embodiment, the pre-defined amount of time is approximately 60 minutes. In some embodiments, the pre-defined amount of time is between 10 minutes and 60 minutes.

If the batch limit or time elapsed condition is not satisfied, then the process 500 waits for more orders from users (at block 518). If the batch limit or time elapsed condition is satisfied, then a logistic planner 530 accumulates data for items, delivery locations and corresponding time windows from all orders in the batch (block 522). At block 524, the logistic planner 530 adds logistic constraint information to the accumulated order data.

At block 526, the logistic planner 530 runs the routing optimizer engine using the order data and the logistic constraint data. The logistic planner 530 checks if the solution or route generated by the routing optimizer engine is valid, i.e. the optimized route with the least cost. (block 528).

If the generated route is not valid, then the logistic planner 530 runs the route optimizer engine again at block 526. In running the route optimizer engine again, the nodes in the generated route are ‘ruined’ (connections between nodes are disassembled or broken) and then are ‘recreated’ (new connections between nodes are created) that generates a route different from the previous route. Thus, in each run a different route is generated.

If the generated route is valid, then the process 500 continues to block 532. At block 532, a shipping system 540 receives the generated route and order data, and transmits instructions to delivery vehicle operators to ship or deliver the batch of orders with minimum cost. The user 510 receives the order at one of the delivery addresses provided by the user. Ideally, the order is delivered or accepted by the user at the first attempt, since the time window that the user is available at a delivery location is known.

FIG. 6 is a schematic illustrating an exemplary user interface 600 for placing an order, according to an example embodiment. As shown in user interface 600, a customer can input multiple delivery locations and a corresponding time for delivery at which the customer will be available at each location. Using this information, the routing system 100 calculates a delivery route that ensures delivery acceptance at the first attempt. This saves cost to the company, since any subsequent attempts for delivery (when the first attempt is unsuccessful) costs more to the company.

FIG. 7 illustrates a network diagram depicting a system 700 for implementing a distributed embodiment of the routing system, according to an example embodiment. The system 700 can include a network 705, user device 710, device 720, server 730, order processing system 740, POS/e-commerce system 750, and database(s) 760. Each of components 710, 720, 730, 740, 750 and 760 is in communication with the network 705.

In an example embodiment, one or more portions of network 705 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

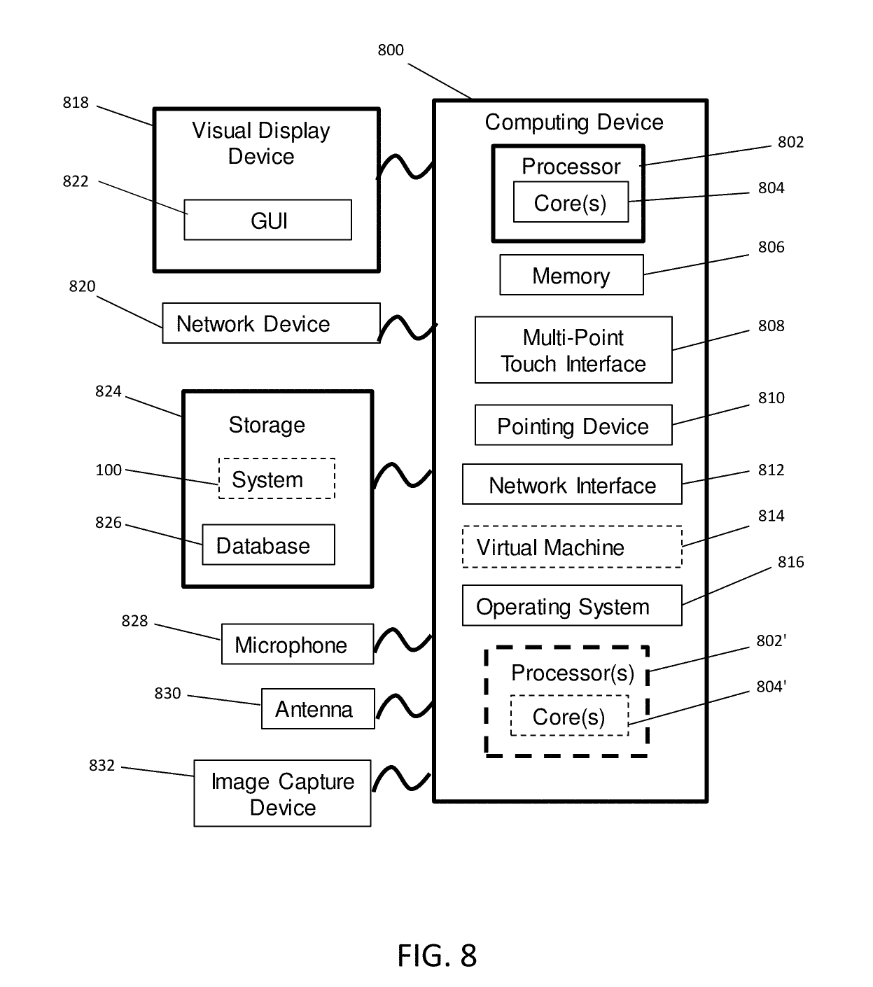

The user device 710 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The device 710 can include one or more components described in relation to computing device 800 shown in FIG. 8. The user device 710 may be used by a customer to place an order. Exemplary user interface 600 may be displayed on the user device 710, and the customer may input at least a first and second destination and corresponding time windows via the user device 710.

The user device 710 may connect to network 705 via a wired or wireless connection. The device 710 may include one or more applications such as, but not limited to, an order placement application, an e-commerce application, a web browser application, and the like.

The device 720 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The device 720 can include one or more components described in relation to computing device 800 shown in FIG. 8. In some embodiments, the device 720 may include one or more modules of the routing system 100, and may perform some of the functionalities of the routing system described herein. The device 720 may connect to network 705 via a wired or wireless connection. The device 720 may include one or more applications such as, but not limited to, a web browser application, a routing application based on the routing system described herein, and others.

In an example embodiment, the device 720 may perform all the functionalities described herein. In other embodiments, the routing system 100 may be included on the device 720, and the server 730 performs the functionalities described herein. In yet another embodiment, the device 720 may perform some of the functionalities, and the server 430 performs the other functionalities described herein.

The order processing system 740 may include a server and/or a computing device, and may include one or more components described in relation to computing device 800 of FIG. 800. The order processing system 740 is configured to manage and process orders placed by customers. The order processing system 740 may receive and store information for the order such as, but not limited to, delivery address, shipping address, customer name, items in the order, and the like. The order processing system 740 may store order data in database(s) 760. In some embodiment, the order processing system 740 may also facilitate shipping or delivery of the order based on the optimized route generated by the routing system 100. The order processing system 740 may connect to network 705 via a wired or wireless connection.

The POS/e-commerce system 750 may include a server and/or a computing device, and may include one or more components described in relation to computing device 800 of FIG. 8. The POS/e-commerce system 750 is configured to manage item inventory information and pricing information. The POS/e-commerce system 750 may enable a customer to browse items, and tender payment for an order. The POS/e-commerce system 750 may receive and store transaction information such as, but not limited to, customer name, transaction amount, payment information, and the like. The POS/e-commerce system 750 may store data in database(s) 760. The POS/e-commerce system 750 may connect to network 705 via a wired or wireless connection.

Each of the server 730 and the database(s) 760 is connected to the network 705 via a wired or wireless connection. The server 730 includes one or more computers or processors configured to communicate with the user device 710, device 720, and database(s) 760 via network 705. The server 730 hosts one or more applications, websites or systems accessed by the user device 710 and device 720 and/or facilitates access to the content of database(s) 760. Database(s) 760 comprise one or more storage devices for storing data and/or instructions (or code) for use by the user device 710, the device 720, and the server 730. The database(s) 760, and/or the server 730 may be located at one or more geographically distributed locations from each other or from the device 720. Alternatively, the database(s) 760 may be included within the server 730.

FIG. 8 is a block diagram of an exemplary computing device 800 that may be used to implement exemplary embodiments of the routing system 100 described herein. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 806 included in the computing device 800 may store computer-readable and computer-executable instructions or software for implementing exemplary embodiments of the routing system 100. The computing device 800 also includes configurable and/or programmable processor 802 and associated core 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling system hardware. Processor 802 and processor(s) 802′ may each be a single core processor or multiple core (804 and 804′) processor.

Virtualization may be employed in the computing device 800 so that infrastructure and resources in the computing device may be shared dynamically. A virtual machine 814 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user may interact with the computing device 800 through a visual display device 818, such as a computer monitor, which may display one or more graphical user interfaces 822 that may be provided in accordance with exemplary embodiments. The computing device 800 may include other I/O devices for receiving input from a user, for example, a keyboard or any suitable multi-point touch interface 808, a pointing device 810 (e.g., a mouse), a microphone 828, and/or an image capturing device 832 (e.g., a camera or scanner). The multi-point touch interface 808 (e.g., keyboard, pin pad, scanner, touch-screen, etc.) and the pointing device 810 (e.g., mouse, stylus pen, etc.) may be coupled to the visual display device 818. The computing device 800 may include other suitable conventional I/O peripherals.

The computing device 800 may also include one or more storage devices 824, such as a hard-drive, CD-ROM, or other computer readable media, for storing data and computer-readable instructions and/or software that implement exemplary embodiments of the routing system 100 described herein. Exemplary storage device 824 may also store one or more databases for storing any suitable information required to implement exemplary embodiments. For example, exemplary storage device 824 can store one or more databases 826 for storing information, such order data, first and second destinations and corresponding time windows, generated routes for delivering orders, and/or any other information to be used by embodiments of the system 100. The databases may be updated manually or automatically at any suitable time to add, delete, and/or update one or more items in the databases.

The computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 800 can include one or more antennas 830 to facilitate wireless communication (e.g., via the network interface) between the computing device 800 and a network. The network interface 812 may include a built-in network adapter, network interface card, PCMCIA network card, card bus network adapter, wireless network adapter, USB network adapter, modem or any other device suitable for interfacing the computing device 800 to any type of network capable of communication and performing the operations described herein. Moreover, the computing device 800 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 800 may run any operating system 816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 816 may be run in native mode or emulated mode. In an exemplary embodiment, the operating system 816 may be run on one or more cloud machine instances.

The following description is presented to enable any person skilled in the art to create and use a computer system configuration and related method and article of manufacture to generate an optimized route for delivering orders. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A routing system comprising:
a database holding data related to a plurality of orders;
a user interface configured to accept an order for delivery of items, the order including a first destination and a corresponding first time window and a second destination and a corresponding second time window;
a server equipped with one or more processors and in communication with the database, the server configured to execute a routing optimizer engine that when executed:
receives data for the plurality of orders, each order including a first destination with a corresponding first time window;
generates and stores an initial route in the database for delivering each order of the plurality of orders at the corresponding first destinations within the first time window by analyzing the data for the plurality of orders;
removes two or more outlier orders from the generated initial route based on pre-defined logistical constraints to form a subset of orders of the plurality of orders;
generates and stores a first partial route for delivering each order of the subset of orders at the corresponding first destinations within the first time window; and
iteratively inserts one of the two or more outlier orders into the subset of orders, where for each iteration, the routing optimizer engine:
generates and stores a second plurality of partial routes for delivering each order of the subset of orders at the corresponding first destination within the first window and the one inserted outlier order at the corresponding second destination within the second time window;
compares the first partial route and the second plurality of partial routes;
determines that the first partial route or one of the second plurality of partial routes is an optimized route between a source and destination based on the pre-defined logistical constraints; and
stores the optimized route in the database.

2. The system of claim 1, wherein the routing optimizer engine is further configured to:
receive the pre-defined logistic constraints including a number of vehicles, hours of operations, and vehicle capacity; and
generate and store the initial route for delivering each order of the plurality of orders at the corresponding first destination within the first time window by analyzing the data for the plurality of orders and the pre-defined logistics constraints.

3. The system of claim 1, wherein the optimizer engine is configured to:
compare a cost of the first partial route and each of the plurality of partial routes; and
determine one of the first partial route or one of the second plurality of partial routes is an optimized route between a source and destination based on the cost.

4. The system of claim 3, wherein the cost includes a fuel component.

5. The system of claim 3, wherein the cost includes a wage component based on a wage owed to an operator of a vehicle performing the optimized route.

6. The system of claim 1, wherein the pre-defined logistic constraint includes a distance radius and a weather criteria.

7. The system of claim 1, wherein the pre-defined logistic constraints includes a user preference from a stored profile of an individual receiving an order.

8. A computer-implemented method for a routing system, the method comprising:
receiving data for a plurality of orders, each order including a first destination with a corresponding first time window and a second destination and a corresponding second time window;
generating and storing an initial route in the database for delivering each order of the plurality of orders at the corresponding first destinations within the first time window by analyzing the data for the plurality of orders;
removing two or more outlier orders from the generated initial route based on pre-defined logistical constraints to form a subset of orders of the plurality of orders;
generating and storing a first partial route for delivering each order of the subset of orders at the corresponding first destinations within the first time window; and
iteratively inserting one of the two or more outlier orders into the subset of orders, wherein each iteration includes:
generating and storing a second plurality of partial routes for delivering each order of the subset of orders at the corresponding first destination within the first window and the one inserted outlier order at the corresponding second destination within the second time window;
comparing the first partial route and the second plurality of partial routes;
determining that the first partial route or one of the second plurality of partial routes is an optimized route between a source and destination based on the pre-defined logistical constraints; and
storing the optimized route in the database.

9. The method of claim 8, further comprising:
receiving the pre-defined logistic constraints including a number of vehicles, hours of operations, and vehicle capacity; and
generating and storing the initial route for delivering each order of the plurality of orders at the corresponding first destination within the first time window by analyzing the data for the plurality of orders and the pre-defined logistics constraints.

10. The method of claim 8, further comprising:
comparing a cost of the first partial route and each of the plurality of partial routes; and
determining one of the first partial route or one of the second plurality of partial routes is an optimized route between a source and destination based on the cost.

11. The method of claim 10, wherein the cost includes a fuel component.

12. The method of claim 10, wherein the cost includes a wage component based on a wage owed to an operator of a vehicle performing the optimized route.

13. The method of claim 8, wherein the pre-defined logistic constraint includes a distance radius and a weather criteria.

14. The method of claim 8, wherein the pre-defined logistic constraints includes a user preference from a stored profile of an individual receiving an order.

15. A non-transitory machine-readable medium storing instructions executable by a processing device, wherein execution of the instructions causes the processing device to implement a method for a routing system, the method comprising:
receiving data for a plurality of orders, each order including a first destination with a corresponding first time window and a second destination and a corresponding second time window;
generating and storing an initial route in the database for delivering each order of the plurality of orders at the corresponding first destinations within the first time window by analyzing the data for the plurality of orders;
removing two or more outlier orders from the generated initial route based on pre-defined logistical constraints to form a subset of orders of the plurality of orders;
generating and storing a first partial route for delivering each order of the subset of orders at the corresponding first destinations within the first time window; and
iteratively inserting one of the two or more outlier orders into the subset of orders, wherein each iteration includes:
generating and storing a second plurality of partial routes for delivering each order of the subset of orders at the corresponding first destination within the first window and the one inserted outlier order at the corresponding second destination within the second time window;
comparing the first partial route and the second plurality of partial routes;
determining that the first partial route or one of the second plurality of partial routes is an optimized route between a source and destination based on the pre-defined logistical constraints; and
storing the optimized route in the database.

16. The non-transitory computer readable medium of claim 15, further comprising:
receiving the pre-defined logistic constraints including a number of vehicles, hours of operations, and vehicle capacity; and
generating and storing the initial route for delivering each order of the plurality of orders at the corresponding first destination within the first time window by analyzing the data for the plurality of orders and the pre-defined logistics constraints.

17. The non-transitory computer readable medium of claim 15, further comprising:
comparing a cost of the first partial route and each of the plurality of partial routes; and
determining one of the first partial route or one of the second plurality of partial routes is an optimized route between a source and destination based on the cost.

18. The non-transitory computer readable medium of claim 17, wherein the cost includes a fuel component.

19. The non-transitory computer readable medium of claim 17, wherein the cost includes a wage component based on a wage owed to an operator of a vehicle performing the optimized route.

20. The non-transitory computer readable medium of claim 15, wherein the pre-defined logistic constraint includes a distance radius and a weather criteria.
